(19) United States
(12) Patent Application Publication
(10) Pub. No.: US 2009/0208021 A1
(43) Pub. Date: Aug. 20, 2009

(54) METHOD AND APPARATUS FOR MANAGING ENCRYPTION KEYS BY MOBILE COMMUNICATION TERMINAL CONNECTED WITH SMARTCARD

(75) Inventors: Ji-Wuck JUNG, Suwon-si (KR); Young-Jip Kim, Suwon-si (KR); Joon-Ho Park, Suwon-si (KR); Byoung-Dai Lee, Seongnam-si (KR); Kyung-Shin Lee, Suwon-si (KR)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/366,389

(22) Filed: Feb. 5, 2009

(30) Foreign Application Priority Data
Feb. 5, 2008 (KR) 10-2008-0011994

(51) Int. Cl. H04L 9/08; H04L 9/00

(52) U.S. Cl. 380/278

(57) ABSTRACT

A method and an apparatus are provided for managing encryption keys by a mobile communication terminal connected to a smartcard that stores the encryption keys. The mobile communication terminal receives and stores encrypted multimedia data, extracts recording key information corresponding to an encryption key from the received multimedia data, determines whether the extracted recording key information has been previously stored in a recording key database, and maps the extracted recording key information to identification information of the received multimedia data and stores mapping data therebetween in the recording key database when the extracted recording key information has not been previously stored in the recording key database.

### PRIORITY

This application claims priority under 35 U.S.C. § 119(a) to a Korean Patent Application filed in the Korean Intellectual Property Office on Feb. 5, 2008 and assigned Serial No. 2008-11994, the entire disclosure of which is incorporated herein by reference.

### BACKGROUND OF THE INVENTION

1. Field of the Invention

The present invention relates generally to mobile communication terminals, and more particularly, to a method and apparatus for managing encryption keys by a mobile communication terminal connected to a smartcard.

2. Description of the Related Art

Open Mobile Alliance (OMA), which is a group for discussing and establishing standards of international portable communication technologies, has defined a portable broadcasting technology standard, Broadcast Services Enabler Suite (BCAST). This standard, which is also referred to as OMA-BCAST, describes various methods for providing portable broadcast services over a portable broadcast network. The OMA-BCAST standard also defines a Service and Content Protection (SCP) technique for protecting portable broadcast content. The OMA-BCAST SCP technique encrypts broadcast content using a particular key, which allows only an authorized user to use the broadcast content.

Depending on an encryption key management scheme, OMA-BCAST SCP is divided into two profiles: a Digital Right Management (DRM) profile using an OMA-DRM standard scheme and a smartcard profile using a key management standard scheme incorporated in a smartcard mounted in a mobile communication terminal.

The OMA-BCAST SCP technique encrypts content transmitted by broadcasting, and stores and records the encrypted content so that only a user having a Service Encryption Key (SEK) or a Program Encryption Key (PEK) is authorized to view the recorded content. For reproduction of an encrypted content file, the user must own an SEK or PEK used to record the content file. The user, if not having the SEK or PEK, must perform a joining procedure or a procedure for purchasing the SEK or PEK, to acquire the SEK or PEK.

In order to determine the SEK or PEK necessary for decryption of the encrypted content file, SEK_ID, being ID information of the SEK, or PEK_ID, being ID information of the PEK, is required. For the smartcard profile, such ID information is in an ID format defined in OMA-BCAST SCP.

The ID information of the SEK or PEK of the smartcard profile may be in a format of “Key Domain ID ∥ MSK ID.” The Key Domain ID, having a length of 3 bytes, is composed of a combination of a mobile country code and a mobile network code. The Multimedia Broadcast Multicast Service (MBMS) Service Key (MSK) ID has a length of 4 bytes, of which the first 2 bytes indicate a key group part and the last 2 bytes indicate a key number part.

The ID information of the SEK or PEK is extracted from a Short Term Key Message (STKM) included in the content file. To reproduce the recorded content file, the mobile communication terminal extracts and analyzes the STKM included in the content file. The mobile communication terminal extracts the SEK or PEK stored in the smartcard using the ID information of the SEK or PEK. To delete the recorded content file, the mobile communication terminal, upon recognizing that the SEK or PEK is not used any longer, deletes the SEK or PEK from the smartcard.

FIG. 1 is a flowchart illustrating a method for managing encryption keys by a mobile communication terminal 10 connected to a smartcard 20, which stores the encryption keys.

In FIG. 1, the mobile communication terminal 10 is connected to the smartcard 20. A content file stored in the mobile communication terminal 10 is referred to as ‘multimedia data’, multimedia data for which a deletion request is received is referred to as ‘first multimedia data’, and the remaining multimedia data except for the first multimedia data is referred to as ‘second multimedia data. ID information of an SEK or ID information of a PEK, which is extracted from an STKM included in the first multimedia data, is referred to as ‘first recording key information’, and ID information of an SEK or ID information of a PEK, which is extracted from an STKM included in one of the second multimedia data, is referred to as ‘second recording key information’.

The mobile communication terminal 10 receives a deletion request for first multimedia data in step S32. The mobile communication terminal 10 extracts first recording key information from an STKM included in the first multimedia data in step S34. The mobile communication terminal 10 extracts second recording key information from an STKM included in one of second multimedia data in step S36.

The mobile communication terminal 10 compares the first recording key information extracted in step S34 with the second recording key information extracted in step S36, in determining whether the first recording key information is identical to the second recording key information in step S38.

If the first recording key information is identical to the second recording key information (YES in step S38), the mobile communication terminal 10 deletes only the first multimedia data in step S48. The fact that the first recording key information and the second recording key information are identical means that the SEK or PEK necessary for decoding the first multimedia data is also required for decoding multimedia data other than the first multimedia data. Thus, the mobile communication terminal 10 deletes only the deletion-requested first multimedia data.

If the first recording key information is not identical to the second recording key information (NO in step S38), the mobile communication terminal 10 determines in step S40 whether there remains any one of second multimedia data from which the second recording key information is not extracted. If there is any one of the second multimedia data from which the second recording key information is not extracted (YES in step S40), the mobile communication terminal 10 extracts the second recording key information from an STKM included in the one of the second multimedia data in step S36. According to the prior art, the mobile communication terminal 10 must confirm that second recording key information extracted from STKMs included in all of the second multimedia data being previously stored in the mobile communication terminal 10 is not identical to the first recording key information. To this end, the mobile communication terminal 10 repeats steps S36 through S40.

If the first recording key information is not identical to the second recording key information extracted from all of the second multimedia data except for the first multimedia data (NO in steps S38 and S40), the mobile communication terminal 10 transmits an encryption key deletion request to the smartcard 20 in step S42. In this step, the mobile communication terminal 10 transmits the first recording key information through the encryption key deletion request.

The smartcard 20 deletes the first recording key information and an encryption key corresponding thereto in step S44. The smartcard 20 discovers the encryption key corresponding to the first recording key information by referring to the first recording key information included in the encryption key deletion request. The smartcard 20 transmits an encryption key deletion response to the mobile communication terminal 10 in step S46, which, when receiving the encryption key deletion response, deletes the first multimedia data in step S48.

In order to support reproduction of stored multimedia data in the smartcard 20, despite the expiration of a service subscription period during which an SEK or a PEK is valid, the SEK or PEK should not be deleted from the smartcard 20 until the stored multimedia data is deleted from the mobile communication terminal 10. However, the smartcard 20 cannot know which multimedia data is maintained in the mobile communication terminal 10. The mobile communication terminal 10 informs the smartcard 20 of recording key information at the time of storage and recording of multimedia data, thereby allowing the smartcard 20 to maintain the multimedia data without deleting the multimedia data, and preventing waste of storage space of the smartcard 20 by deleting an encryption key which is not necessary any more due to deletion of the multimedia data.

The encryption key is maintained for a minimum of several hours and for a maximum of several weeks, and the mobile communication terminal 10 can perform recording a number of times using the same encryption key. Thus, the mobile communication terminal 10, when deleting particular multimedia data, needs to analyze an STKM included in stored multimedia data in order to determine whether the stored multimedia data has the same encryption key as the particular multimedia data, i.e., whether there exists other multimedia data having the same recording key information as that of the particular multimedia data. The mobile communication terminal 10 transmits the encryption key deletion request to the smartcard 20 only when the same recording key information is not included in any other multimedia data.

Such a procedure requires more time to acquire recording key information and to determine whether recording key information of multimedia data to be deleted is identical to recording key information of any other multimedia data, as the amount of multimedia data stored in the mobile communication terminal 10 increases. Furthermore, a process of extracting recording key information from a plurality of multimedia data stored in the mobile communication terminal 10 for comparison may increase the amount of computation of the mobile communication terminal 10, and a user of the mobile communication terminal 10 may feel that response time is long during deletion of multimedia data.

### SUMMARY OF THE INVENTION

The present invention has been made to address at least the above problems and/or disadvantages and to provide at least the advantages described below. Accordingly, an aspect of the present invention provides a method and apparatus for easily managing encryption keys by a mobile communication terminal connected to a smartcard, which stores the encryption keys.

According to one aspect of the present invention, a method is provided for managing encryption keys by a mobile communication terminal connected to a smartcard, which stores the encryption keys. Encrypted multimedia data provided from a Digital Multimedia Broadcast (DMB) service provider is received and stored. Recording key information is extracted that corresponds to an encryption key necessary for decryption of the received multimedia data from stream information included in the received multimedia data. It is determined whether the extracted recording key information has been previously stored in a recording key database which stores mapping data between recording key information of previously stored multimedia data and identification information of the previously stored multimedia data. The extracted recording key information is mapped to identification information of the received multimedia data and mapping data is stored therebetween in the recording key database when the extracted recording key information has not been previously stored in the recording key database.

According to another aspect of the present invention, a method is provided for managing encryption keys by a mobile communication terminal connected to a smartcard, which stores the encryption keys. Recording key information is extracted that corresponds to an encryption key necessary for decryption of the deletion-requested multimedia data from stream information included in the deletion-requested multimedia data upon receipt of a deletion request for multimedia data. It is determined whether identification information of other multimedia data has been mapped to the extracted recording key information in a recording key database which stores mapping data between recording key information of previously stored multimedia data and identification information of the previously stored multimedia data. An encryption key deletion request is transmitted to the smartcard if the identification information of other multimedia data has not been mapped to the extracted recording key information. The extracted recording key information and the identification information of the deletion-requested multimedia data are deleted from the recording key database upon receipt of an encryption key deletion response corresponding to the encryption key deletion request from the smartcard. The deletion-requested multimedia data is deleted.

According to a further aspect of the present invention, an apparatus is provided for managing encryption keys by a mobile communication terminal connected to a smartcard, which stores the encryption keys. The apparatus includes a storage unit for storing one or more encrypted multimedia data files, a recording key database for storing mapping data between recording key information extracted from stream information included in the one or more encrypted multimedia data files and identification information of the one or more encrypted multimedia data files, and a communication interface unit for transmitting an encryption key deletion request to the smartcard. The apparatus also includes a controller for, when receiving a deletion request for one of the one or more encrypted multimedia data files, extracting recording key information from stream information included in the deletion-requested multimedia data file, determining whether the extracted recording key information has been mapped to identification information of another multimedia data file by referring to the recording key database, and controlling the communication interface unit to transmit an encryption key deletion request to the smartcard if the extracted recording key information has not been mapped to the identification information of another multimedia data file.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a flowchart illustrating a method for managing encryption keys by a mobile communication terminal connected to a smartcard, which stores the encryption keys;

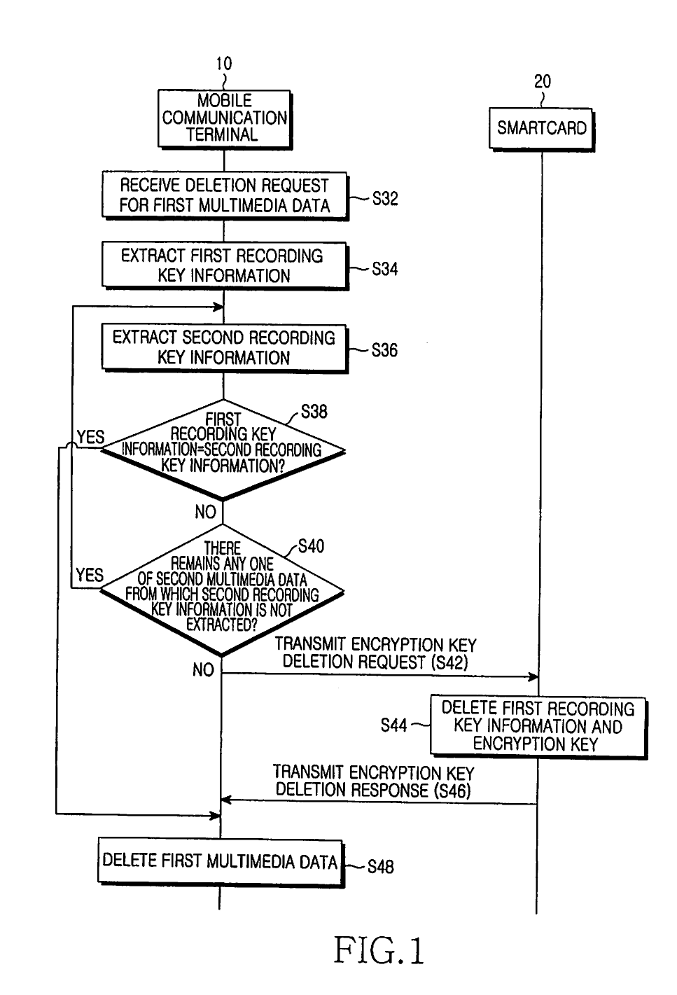

FIG. 2 is a block diagram of a mobile communication terminal and a smartcard according to an embodiment of the present invention;

FIG. 3 is a flowchart illustrating a method for managing encryption keys by a mobile communication terminal connected to a smartcard, which stores the encryption keys, according to an embodiment of the present invention;

FIG. 4 is a diagram illustrating a structure of a recording key database according to an embodiment of the present invention;

FIG. 5 is a diagram illustrating a structure of a recording key database according to another embodiment of the present invention;

FIG. 6 is a flowchart illustrating a method for managing encryption keys by a mobile communication terminal connected to a smartcard, which stores the encryption keys, according to another embodiment of the present invention; and

FIGS. 7A through 7D are diagrams illustrating structures of a recording key database when recording key information is deleted according to an embodiment of the present invention.

### DETAILED DESCRIPTION OF PREFERRED EMBODIMENTS

Preferred embodiments of the present invention are described in detail with reference to the accompanying drawings. The same or similar components are designated by the same or similar reference numerals although they are illustrated in different drawings. Detail descriptions of constructions or processes known in the art may be omitted to avoid obscuring the subject matter of the present invention.

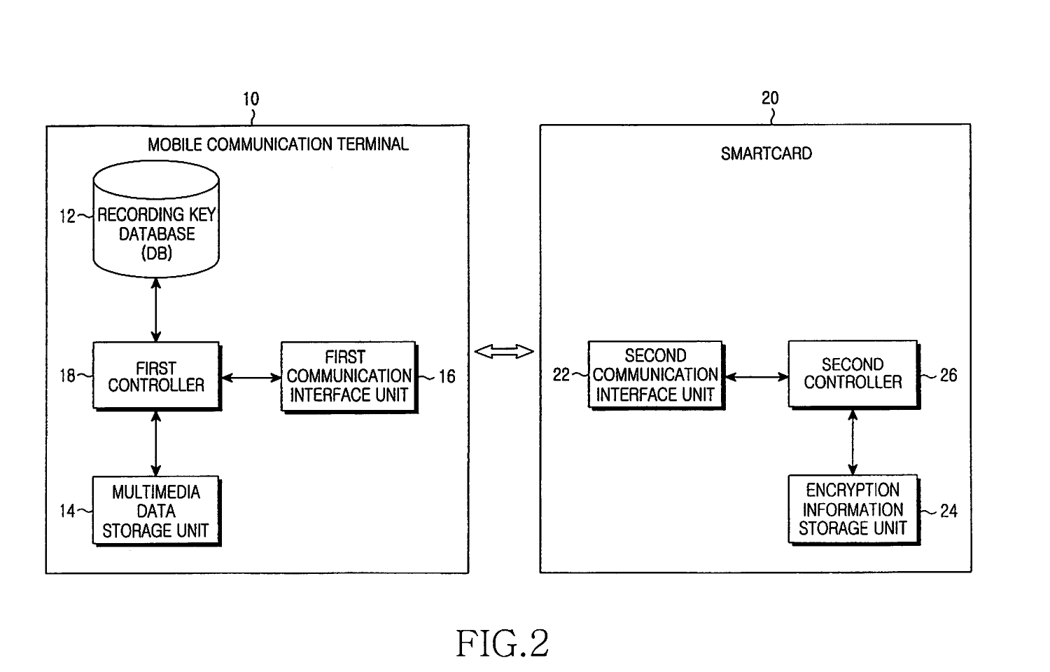

FIG. 2 is a block diagram of a mobile communication terminal 10 and a smartcard 20 according to an embodiment of the present invention.

The smartcard 20, installed in the mobile communication terminal 10, receives an encryption key deletion command from the mobile communication terminal 10 and deletes a stored encryption key and recording key information stored corresponding to the encryption key according to the received command.

The mobile communication terminal 10 includes a recording key database 12, a multimedia data storage unit 14, a first communication interface unit 16, and a first controller 18. The smartcard 20 includes a second communication interface unit 22, an encryption information storage unit 24, and a second controller 26.

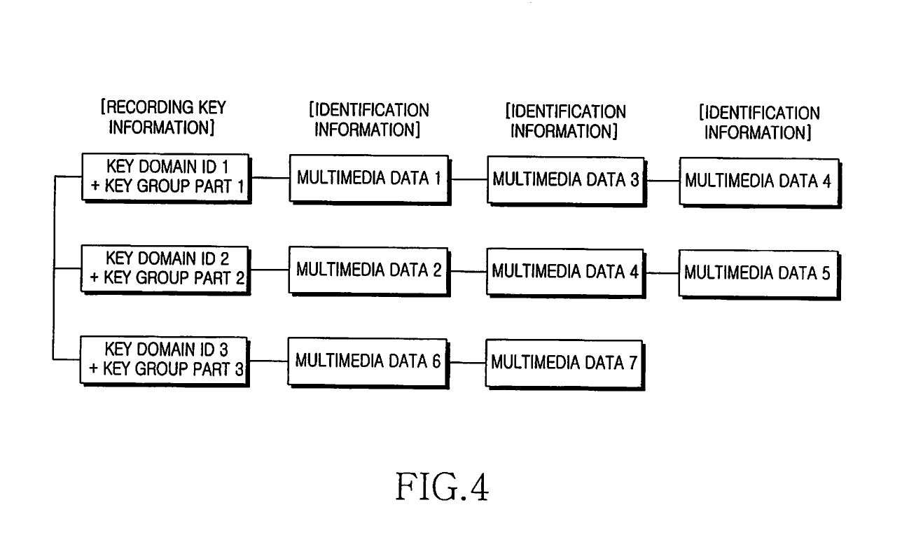

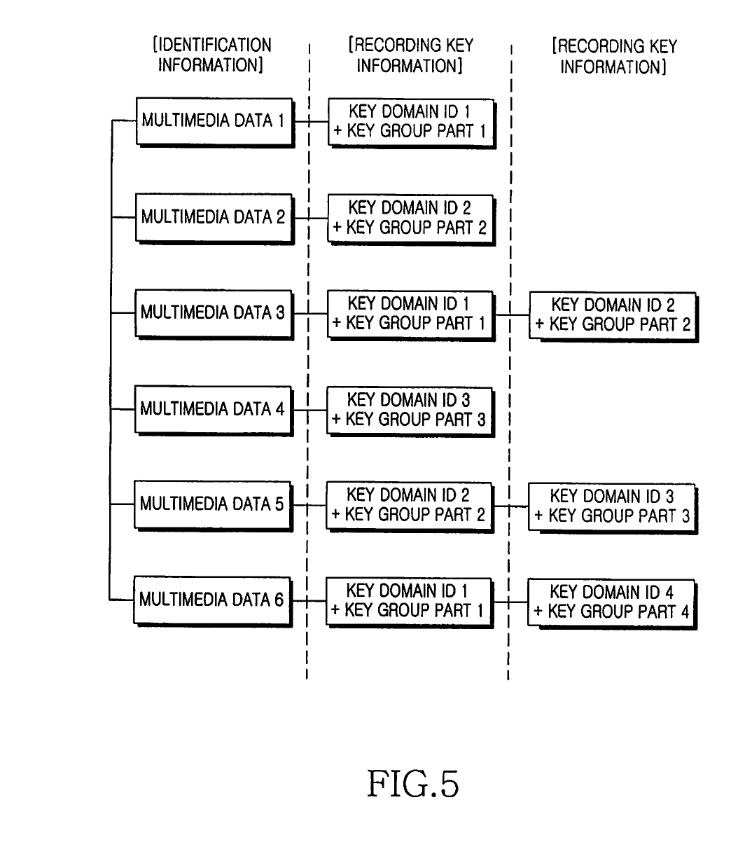

The recording key database (DB) 12 stores mapping data between identification information for identifying respective multimedia data stored in the multimedia data storage unit 14 and recording key information of the multimedia data. The identification information and the recording key information may be stored in the recording key database 12 in the form of a table as illustrated in FIGS. 4 and 5.

The multimedia data storage unit 14 stores multimedia data received by the mobile communication terminal 10. The mobile communication terminal 10 may receive multimedia data from, for example, a Digital Media Broadcast (DMB) service provider, through a wireless communication unit (not shown). The mobile communication terminal 10 according to the current embodiment may include a Radio Frequency (RF) transmitter (not shown) for up-converting a frequency of a transmission signal and amplifying the up-converted transmission signal and an RF receiver (not shown) for low-noise-amplifying a received signal and down-converting a frequency of the low-noise-amplified signal.

The first communication interface unit 16 communicates with the smartcard 20. When new multimedia data received by the mobile communication terminal 10 is stored in the multimedia data storage unit 14, the first communication interface unit 16 may transmit an encryption key validity term renewal (or update) request to the smartcard 20 under the control of the first controller 18, which is described in greater detail below.

Upon receiving a deletion request for one of the multimedia data stored in the multimedia data storage unit 14, the first communication interface unit 16, under the control of the first controller 18, may transmit an encryption key deletion request to the smartcard 20 for deleting corresponding recording key information and encryption key and receive from the smartcard 20 an encryption key deletion response.

The first controller 18 controls overall operations of the mobile communication terminal 10. When new multimedia data or a deletion request for multimedia data stored in the multimedia data storage unit 14 is received by the mobile communication terminal 10, the first controller 18 extracts recording key information from stream information included in the new multimedia data or the deletion-requested multimedia data.

Since multimedia data received by the mobile communication terminal 10 is encrypted data, the mobile communication terminal 10 has to decrypt the encrypted multimedia data in order to display the received multimedia data. To determine an encryption key necessary for decryption of the encrypted multimedia data, the first controller 18 uses stream information included in the encrypted multimedia data. The stream information may be, for example, a Short Term Key Message (STKM), and may be transmitted through a header of the multimedia data. The stream information includes recording key information corresponding to ID information of an encryption key. The first controller 18 extracts the recording key information from the stream information, determines an encryption key necessary for encryption or decryption of the multimedia data among encryption keys stored in the smartcard 20 using the extracted recording key information, and requests the encryption key.

The first controller 18 also manages the recording key database 12. When new multimedia data is received by the mobile communication terminal 10, the first controller 18 extracts recording key information from stream information included in the received multimedia data and determines whether the extracted recording key information has been previously stored in the recording key database 12. If the extracted recording key information has not been stored in the recording key database 12, the first controller 18 maps the extracted recording key information to identification information of the multimedia data and stores mapping data therebetween in the recording key database 12.

If the extracted recording key information has not been stored in the recording key database 12, an encryption key stored in the smartcard 20 is not used to record the new multimedia data. This also indicates that a validity term of the encryption key stored in the smartcard 20 is identical to a validity term being applicable at the time of provision of the encryption key by a DMB service provider. The applicable validity term is usually identical to an agreed term during which the DMB service provider is supposed to provide multimedia data to the mobile communication terminal 10. Even after the expiration of the agreed term, multimedia data stored in the mobile communication terminal 10 needs to be displayed. Thus, the first controller 18 renews (or updates) the validity term of the encryption key previously stored in the smartcard 20 in order to allow the multimedia data stored in the mobile communication terminal 10 to be decrypted and displayed, even though the agreed term has expired.

The first controller 18, upon receiving a deletion request for multimedia data stored in the multimedia data storage unit 14, extracts recording key information from stream information included in the deletion-requested multimedia data. The first controller 18 determines whether there exists other identification information mapped to recording key information of the deletion-requested multimedia data by referring to the recording key database 12. More specifically, the first controller 18 determines whether there exists other multimedia data, which uses the same recording key information as that of the deletion-requested multimedia data. If such other multimedia data does not exist, the first controller 18 transmits an encryption key deletion request to the smartcard 20 through the first communication interface unit 16. When receiving an encryption key deletion response corresponding to the encryption key deletion request from the smartcard 20 through the first communication interface unit 16, the first controller 18 deletes the extracted recording key information and identification information of the multimedia data mapped thereto from the recording key database 12.

If there exists other identification information mapped to the recording key information of the deletion-requested multimedia data, the first controller 18 deletes only the identification information of the deletion-requested multimedia data from the recording key database 12. If there is other identification information mapped to the recording key information, it means that other multimedia data uses the same encryption key as that used by the deletion-requested multimedia data. Therefore, the first controller 18 has to maintain the encryption key stored in the smartcard 20.

The smartcard 20 includes a second communication interface unit 22, an encryption information storage unit 24, and a second controller 26.

The second communication interface unit 22 communicates with the mobile communication terminal 10. The second communication interface unit 22 receives an encryption key deletion request transmitted from the first communication interface unit 16 of the mobile communication terminal 10 and delivers the encryption key deletion request to the second controller 26 which is described in greater detail below. The second communication interface unit 22, under the control of the second controller 26, also transmits an encryption key deletion response to the mobile communication terminal 10 corresponding to the encryption key deletion request transmitted from the mobile communication terminal 10.

The encryption information storage unit 24 stores mapping data between encryption keys necessary for encryption or decryption of multimedia data stored in the multimedia data storage unit 14 of the mobile communication terminal 10 and recording key information corresponding to the encryption keys.

The second controller 26 controls overall operations of the smartcard 20.

When an encryption key validity term renewal request from the mobile communication terminal 10 through the second communication interface unit 22 is received, the second controller 26 refers to recording key information included in the encryption key validity term renewal request in order to determine an encryption key corresponding to the recording key information. Preferably, according to an embodiment of the present invention, the encryption information storage unit 24 may store mapping data between encryption keys and recording key information including respective ID information of the encryption keys. The second controller 26 determines the encryption key and renews the validity term of the encryption key. The second controller 26 also generates an encryption key validity term renewal response indicating that renewal of the validity term of the encryption key has been completed, and transmits the encryption key validity term renewal response to the mobile communication terminal 10 through the second communication interface unit 22.

When an encryption key deletion request from the mobile communication terminal 10 through the second communication interface unit 22 is received, the second controller 26 determines an encryption key by referring to recording key information included in the encryption key deletion request, and deletes the encryption key. The second controller 26 also generates an encryption key deletion response indicating that deletion of the encryption key has been completed, and transmits the encryption key deletion response to the mobile communication terminal 10 through the second communication interface unit 22.

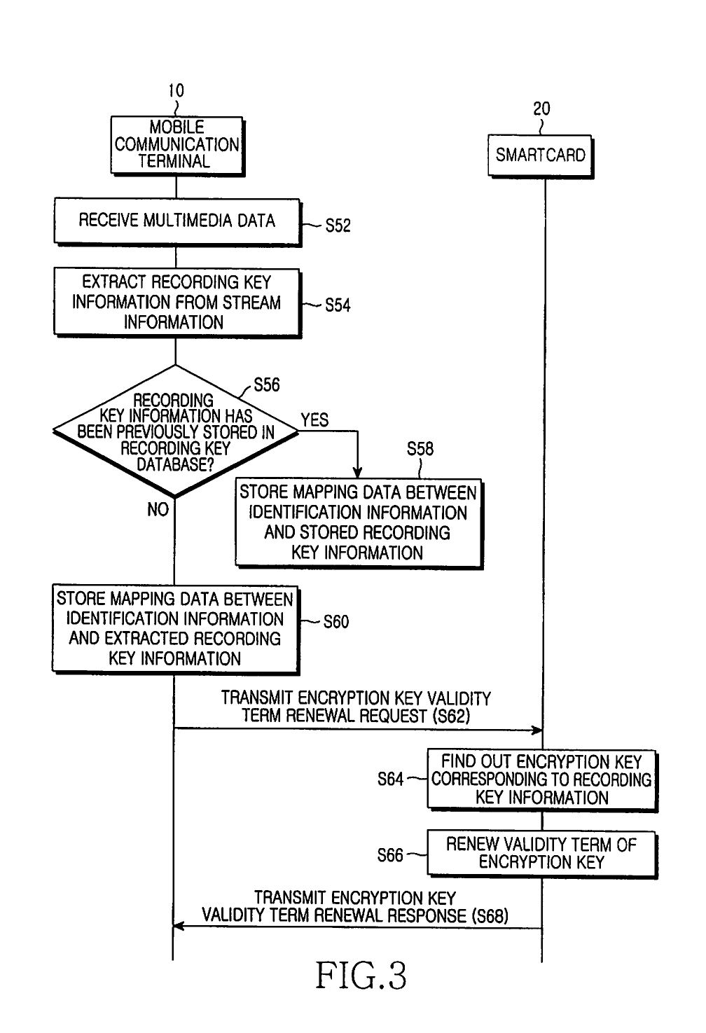

FIG. 3 is a flowchart illustrating a method for managing encryption keys by the mobile communication terminal 10 connected to the smartcard 20, which stores the encryption keys, according to an embodiment of the present invention.

In FIG. 3, the mobile communication terminal 10 maintains the recording key database 12, which stores respective identification information of all multimedia data stored in the multimedia data storage unit 14 and recording key information mapped to the respective identification information.

The mobile communication terminal 10 receives multimedia data in step S52. The mobile communication terminal 10 may receive multimedia data from, for example, a DMB service provider. In step S54, the first controller 18 of the mobile communication terminal 10 extracts recording key information from stream information included in the multimedia data received in step S52.

The first controller 18 determines whether the extracted recording key information has been previously stored in the recording key database 12 in step S56. If the extracted recording key information has been previously stored in the recording key database 12 (YES in step S56), the first controller 18 maps the recording key information stored in the recording key database 12 to identification information of the multimedia data received in step S54 and stores mapping data therebetween in the recording key database 12 in step S58. In other words, the recording key information has already been mapped to identification information of multimedia data other than the multimedia data received in step S52 and stored in the recording key database 12.

If the extracted recording key information has not been stored in the recording key database 12 (NO in step S56), the first controller 18 maps the extracted recording key information to identification information of the received multimedia data and stores mapping data in the recording key database 12 in step S60. The first controller 18 transmits an encryption key validity term renewal request including the recording key information to the smartcard 20 through the first communication interface unit 16 in step S62. The encryption key validity term renewal request transmitted from the mobile communication terminal 10 is received by the smartcard 20 through the second communication interface unit 22. In an embodiment of the present invention, the recording key information is transmitted through the encryption key validity term renewal request in order to determine an encryption key corresponding to the transmitted recording key information from among encryption keys stored in the smartcard 20.

The second controller 26 of the smartcard 20 determines an encryption key corresponding to the recording key information in step S64. The second controller 26 renews the validity term of the encryption key in step S66. The second controller 26 transmits an encryption key validity term renewal response through the second communication interface unit 22 in step S68.

In FIG. 3, the encryption key may be a Service Encryption Key (SEK) or a Program Encryption Key (PEK). When the mobile communication terminal 10 uses the SEK and the PEK exchangeably, both the SEK and the PEK can be applied to encryption of multimedia data. Thus, the recording key information includes ID information of the SEK or ID information of the PEK.

FIG. 4 is a diagram illustrating a structure of the recording key database 12 according to an embodiment of the present invention.

The recording key database 12 stores mapping data between recording key information and identification information of multimedia data under the control of the first controller 18. The recording key database 12 illustrated in FIG. 4 stores recording key information, to each of which at least one identification information is mapped.

Referring to FIG. 4, recording key information is in a format of ‘Key Domain ID+Key Group Part’ including both a key domain ID and a key group part. The key domain ID is domain ID information of an encryption key and the key group part indicates a type of multimedia data, e.g., news, sports, drama, or the like. The first controller 18 of the mobile communication terminal 10 extracts the recording key information from stream information, e.g., an STKM, included in the multimedia data.

In FIG. 4, identification information mapped to recording key information is a file name of multimedia data. Although a file name of multimedia data is used as an example of identification information in this embodiment of the present invention, any data capable of identifying each of a plurality of multimedia data stored in the multimedia data storage unit 14 of the mobile communication terminal 10 can be used as identification information mapped to recording key information.

‘Key Domain ID 1+Key Group Part 1’, ‘Key Domain ID 2+Key Group Part 2’, and ‘Key Domain ID 3+Key Group Part 3’ are recording key information and ‘Multimedia data 1’, ‘Multimedia data 2’, ‘Multimedia data 3’, ‘Multimedia data 4’, ‘Multimedia data 5’, ‘Multimedia data 6’, and ‘Multimedia data 7’ are identification information.

In FIG. 4, the identification information ‘Multimedia data 1’, ‘Multimedia data 3’, and ‘Multimedia data 4’ are mapped to the recording key information ‘Key Domain ID 1+Key Group Part 1’; the identification information ‘Multimedia data 2’, ‘Multimedia data 4’, and ‘Multimedia data 5’ are mapped to the recording key information ‘Key Domain ID 2+Key Group Part 2’; and the identification information ‘Multimedia data 6’ and ‘Multimedia data 7’ are mapped to the recording key information ‘Key Domain ID 3+Key Group Part 3’. In this way, the recording key database 12 may store recording key information, to each of which identification information of a plurality of multimedia data are mapped.

Single identification information may also be mapped to a plurality of recording key information. For example, the identification information ‘Multimedia data 4’ is mapped to both the recording key information ‘Key Domain ID 1+Key Group Part 1’ and the recording key information ‘Key Domain ID 2+Key Group Part 2’. In this case, when the mobile communication terminal 10 deletes the multimedia data having the identification information ‘Multimedia data 4’, both the identification information mapped to ‘Key Domain ID 1+Key Group Part 1’ and the identification mapped to ‘Key Domain ID 2+Key Group Part 2’ have to be deleted.

FIG. 5 is a diagram illustrating a structure of the recording key database 12 according to another embodiment of the present invention.

In FIG. 5, the recording key database 12 stores mapping data between identification information of respective multimedia data and recording key information.

In FIG. 5, like in FIG. 4, recording key information is in a format of ‘Key Domain ID+Key Group Part’ and identification information of multimedia data is expressed as a file name of the multimedia data.

‘Multimedia data 1’, ‘Multimedia data 2’, ‘Multimedia data 3’, ‘Multimedia data 4’, ‘Multimedia data 5’, and ‘Multimedia data 6’ are identification information, and ‘Key Domain ID 1+Key Group Part 1’, ‘Key Domain ID 2+Key Group Part 2’, ‘Key Domain ID 3+Key Group Part 3’, and ‘Key Domain ID 4+Key Group Part 4’ are recording key information.

Referring to FIG. 5, the identification information ‘Multimedia data 1’ is mapped to the recording key information ‘Key Domain ID 1+Key Group Part 1’, the identification information ‘Multimedia data 2’ is mapped to the recording key information ‘Key Domain ID 2+Key Group Part 2’, the identification information ‘Multimedia data 3’ is mapped to both the recording key information ‘Key Domain ID 1+Key Group Part 1’ and the recording key information ‘Key Domain ID 2+Key Group Part 2’, the identification information ‘Multimedia data 4’ is mapped to the recording key information ‘Key Domain ID 3+Key Group Part 3’, the identification information ‘Multimedia data 5’ is mapped to both the recording key information ‘Key Domain ID 2+Key Group Part 2’ and the recording key information ‘Key Domain ID 3+Key Group Part 3’, and the identification information ‘Multimedia data 6’ is mapped to both the recording key information ‘Key Domain ID 1+Key Group Part 1’ and the recording key information ‘Key Domain ID 4+Key Group Part 4’. In this way, the recording key database 12 may store identification information, to each of which a plurality of recording key information are mapped.

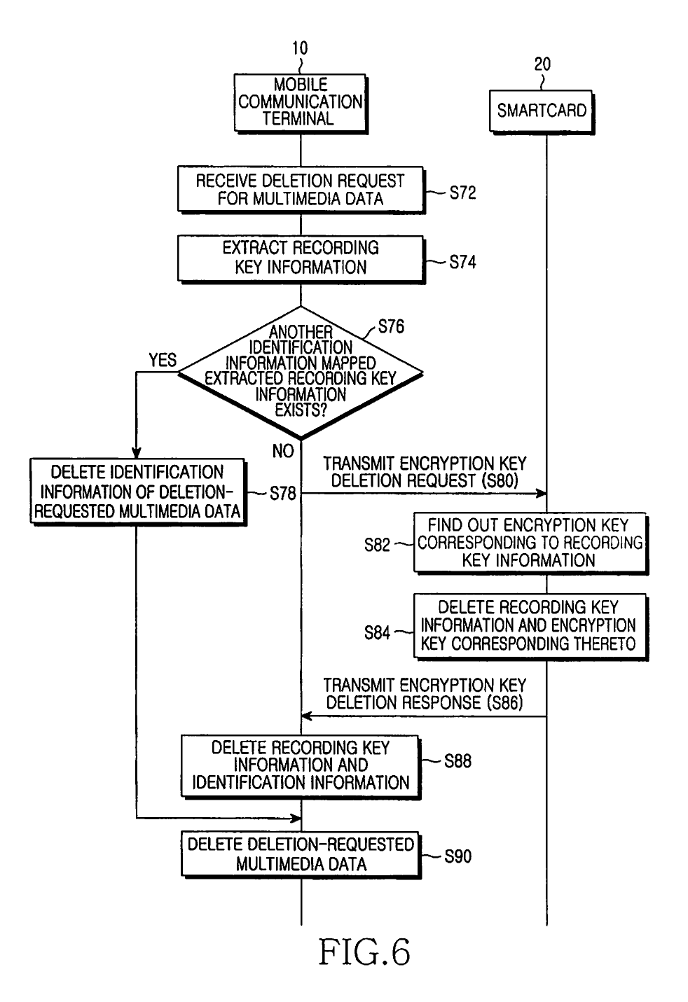

FIG. 6 is a flowchart illustrating a method for managing encryption keys by the mobile communication terminal 10 connected to the smartcard 20 which stores the encryption keys according to another embodiment of the present invention.

The mobile communication terminal 10 receives a deletion request for multimedia data in step S72. The mobile communication terminal 10 may receive a deletion request for multimedia data stored in the multimedia data storage unit 14 through a key input unit (not shown).

The first controller 18 extracts recording key information of the deletion-requested multimedia data in step S74. Respective multimedia data stored in the multimedia data storage unit 14 includes stream information. The first controller 18 extracts recording key information from the stream information. The recording key information may be ID information of an SEK or ID information of a PEK.

The first controller 18 determines whether other identification information mapped to the extracted recording key information exists in the recording key database 12 in step S76. To this end, the first controller 18 may search for identification information mapped to the extracted recording key information. If identification information mapped to the recording key information is only identification information of the deletion-requested multimedia data, the first controller 18 determines that there does not exist other identification information mapped to the extracted recording key information. On the other hand, if other identification information has been mapped to the extracted recording key information and stored in the recording key database 12, the first controller 18 determines that other identification information mapped to the extracted recording key information exists in the recording key database 12.

If other identification information mapped to the extracted recording key information exists in the recording key database 12 (YES in step S76), the first controller 18 deletes only the identification information of the deletion-requested multimedia data from the recording key database 12 in step S78.

If other identification information mapped to the extracted recording key information does not exist in the recording key database 12 (NO in step S76), the first controller 18 transmits an encryption key deletion request to the smartcard 20 through the first communication interface unit 16 in step S80. The first controller 18 controls the mobile communication terminal 10 to transmit the recording key information through the encryption key deletion request.

The smartcard 20 receives the encryption key deletion request from the mobile communication terminal 10 through the second communication interface unit 22. The second controller 26 of the smartcard 20 determines an encryption key corresponding to recording key information in step S82. Since the encryption key deletion request includes recording key information, the second controller 26 can determine the encryption key using the recording key information. In the current embodiment, the recording key information includes ID information of the encryption key, and the first controller 18 or the second controller 26 can determine the target encryption key among encryption keys stored in the encryption information storage unit 24 using the ID information of the encryption key.

The smartcard 20 deletes the recording key information and the encryption key corresponding to the recording key information in step S84. The smartcard 20 also transmits an encryption key deletion response to the mobile communication terminal 20 indicating that deletion of the recording key information and the encryption key has been completed in step S86.

The first controller 18 of the mobile communication terminal 10, upon receipt of the encryption key deletion response through the first communication interface unit 16, deletes the recording key information and identification information mapped thereto from the recording key database 12 in step S88. In step S90, the first controller 18 deletes the multimedia data for which the deletion request is received in step S72.

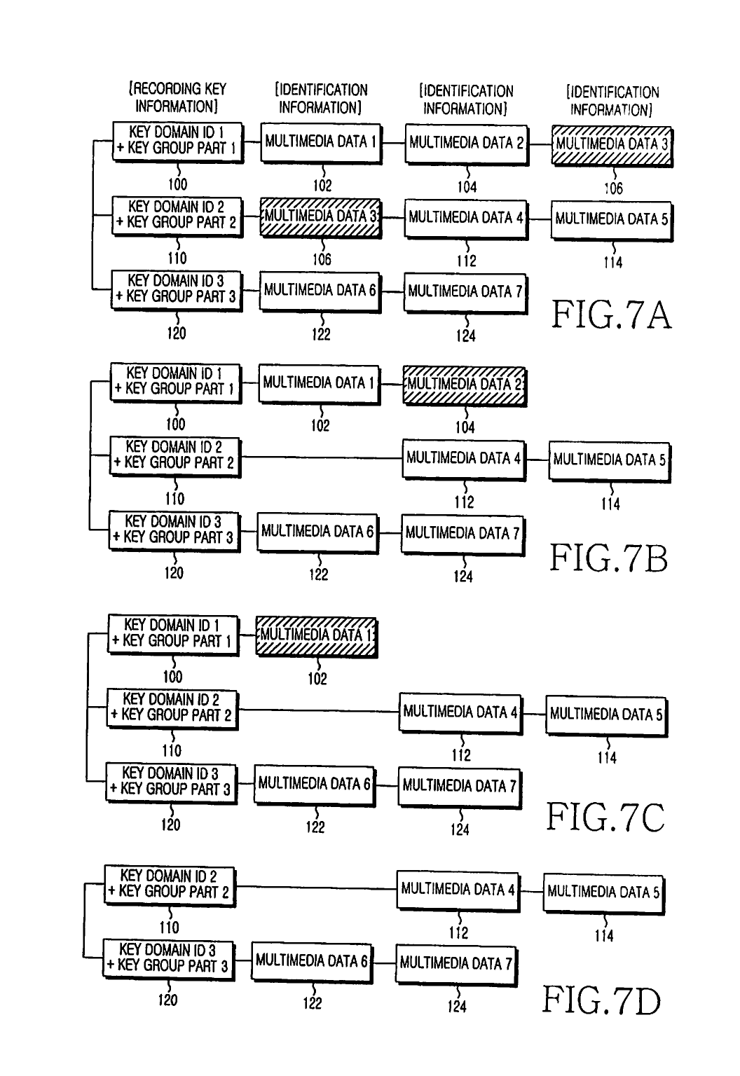

FIGS. 7A through 7D are diagrams illustrating structures of the recording key database 12 when recording key information is deleted according to an embodiment of the present invention.

As illustrated in FIG. 7A, in the recording key database 12, recording key information ‘Key Domain ID 1+Key Group Part 1’ 100 is mapped to identification information ‘Multimedia data 1’ 102, ‘Multimedia data 2’ 104, and ‘Multimedia data 3’ 106; recording key information ‘Key Domain ID 2+Key Group Part 2’ 110 is mapped to identification information ‘Multimedia data 3’ 106, ‘Multimedia data 4’ 112, and ‘Multimedia data 5’ 114; and recording key information ‘Key Domain ID 3+Key Group Part 3’ 120 is mapped to identification information ‘Multimedia data 6’ 122 and ‘Multimedia data 7’ 124.

In FIG. 7A, it is assumed that multimedia data having the identification information ‘Multimedia data 3’ 106 is to be deleted. The identification information ‘Multimedia data 3’ 106 is mapped to both the recording key information ‘Key Domain ID 1+Key Group Part 1’ 100 and the recording key information ‘Key Domain ID 2+Key Group Part 2’ 110. The recording key information ‘Key Domain ID 1+Key Group Part 1’ 100 and the recording key information ‘Key Domain ID 2+Key Group Part 2’ 110 are also mapped to other identification information than the identification information ‘Multimedia Data 3’ 106. Thus, the first controller 18 of the mobile communication terminal 10 deletes only the identification information ‘Multimedia data 3’ 106 from the recording key database 12.

FIG. 7B illustrates a structure of the recording key database 12 from which only the identification information ‘Multimedia data 3’ 106 is deleted. In FIG. 7B, it is assumed that multimedia data having the identification information ‘Multimedia data 2’ 104 is to be deleted. The identification information ‘Multimedia data 2’ 104 is mapped to the recording key information ‘Key Domain ID 1+Key Group Part 1’ 100. Referring to FIG. 7B, the recording key information ‘Key Domain ID 1+Key Group Part 1’ 100 is mapped to the identification information ‘Multimedia data 1’ 102 as well as ‘Multimedia data 2’ 104. Thus, even if the multimedia data having the identification information ‘Multimedia data 2’ 104 is deleted, an SEK or a PEK mapped to the recording key information ‘Key Domain ID 1+Key Group Part 1’ 100 is still necessary for decryption of multimedia data having the identification information ‘Multimedia data 1’ 102. Therefore, the first controller 18 deletes only the identification information ‘Multimedia data 2’ 104 from the recording key database 12.

FIG. 7C illustrates a structure of the recording key database 12 from which the identification ‘Multimedia data 2’ 104 is deleted. In FIG. 7C, it is assumed that multimedia data having the identification information ‘Multimedia data 1’ 102 is to be deleted. The identification information ‘Multimedia data 1’ 102 is mapped to the recording key information ‘Key Domain ID 1+Key Group Part 1’ 100. Since only the identification information ‘Multimedia data 1’ 102 is mapped to the recording key information ‘Key Domain ID 1+Key Group Part 1’ 100, an SEK or a PEK necessary for decryption of the multimedia data having the identification information ‘Multimedia data 1’ 102 is not required if the multimedia data having the identification information ‘Multimedia data 1’ 102 is deleted. Thus, the mobile communication terminal 10 has to delete not only the multimedia data having the identification information ‘Multimedia data 1’ 102 but also the SEK or the PEK stored for decryption of the multimedia data. The first controller 18 also deletes corresponding recording key information among recording key information which is information used to determine an SEK or a PEK necessary for decryption of respective multimedia data.

In FIG. 7D, both the recording key information ‘Key Domain ID 1+Key Group Part 1’ 100 and the identification information ‘Multimedia data 1’ 102 are deleted from the recording key database 12 by the first controller 18. In FIG. 7D, recording key information stored in the recording key database 12 are ‘Key Domain ID 2+Key Group Part 2’ 110 and ‘Key Domain ID 3+Key Group Part 3’ 120.

According to embodiments of the present invention, a method and apparatus for easily managing encryption keys by a mobile communication terminal connected to a smartcard, which stores the encryption keys is provided.

Moreover, the mobile communication terminal, according to an embodiment of the present invention, can easily know whether recording key information of newly received multimedia data has been mapped to identification information of previously stored multimedia data, by referring to the recording key database. Thus, the mobile communication terminal does not need to extract recording key information of all the previously stored multimedia data for comparison with the recording key information of the newly received multimedia data.

Furthermore, the mobile communication terminal, according to an embodiment of the present invention, can easily know whether recording key information of deletion-requested multimedia data is mapped to identification information of multimedia data other than the deletion-requested multimedia data, by referring to the recording key database. Thus, the mobile communication terminal does not have to extract recording key information of all the previously stored multimedia data for comparison with the recording key information of the deletion-requested multimedia data.

In addition, since the mobile communication terminal does not have to extract recording key information of all the previously stored multimedia data by referring to the recording key database, the amount of computation can be reduced and processing speed in reception or deletion of multimedia data can be increased.

While the present invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for managing encryption keys by a mobile communication terminal connected to a smartcard that stores the encryption keys, the method comprising the steps of:
receiving and storing encrypted multimedia data provided from a Digital Multimedia Broadcast (DMB) service provider;
extracting recording key information corresponding to an encryption key necessary for decryption of the received multimedia data from stream information included in the received multimedia data;
determining whether the extracted recording key information has been previously stored in a recording key database that stores mapping data between recording key information of previously stored multimedia data and identification information of the previously stored multimedia data; and
mapping the extracted recording key information to identification information of the received multimedia data and storing mapping data therebetween in the recording key database, when the extracted recording key information has not been previously stored in the recording key database.

2. The method of claim 1, further comprising:
transmitting an encryption key validity term renewal request including the extracted recording key information to the smartcard.

3. The method of claim 2, further comprising:
receiving, by the smartcard, the encryption key validity term renewal request; and
determining, by the smartcard, an encryption key corresponding to the recording key information from among previously stored encryption keys and renewing a validity term of the encryption key.

4. The method of claim 1, further comprising:
mapping the identification information of the received multimedia data to recording key information stored in the recording key database and storing mapping data therebetween, when the extracted recording key information has been previously stored in the recording key database.

5. The method of claim 1, wherein the encryption key comprises at least one of a Service Encryption Key (SEK) and a Program Encryption Key (PEK).

6. The method of claim 4, wherein the recording key information comprises at least one of ID information of the SEK and ID information of the PEK.

7. A method for managing encryption keys by a mobile communication terminal connected to a smartcard that stores the encryption keys, the method comprising the steps of:
upon receipt of a deletion request of multimedia data, extracting recording key information corresponding to an encryption key necessary for decryption of the deletion-requested multimedia data from stream information included in the deletion-requested multimedia data;
determining whether identification information of other multimedia data has been mapped to the extracted recording key information in a recording key database that stores mapping data between recording key information of previously stored multimedia data and identification information of the previously stored multimedia data;
transmitting an encryption key deletion request to the smartcard, when the identification information of other multimedia data has not been mapped to the extracted recording key information;
upon receipt of an encryption key deletion response from the smartcard corresponding to the encryption key deletion request, deleting the extracted recording key information and the identification information of the deletion-requested multimedia data from the recording key database; and
deleting the deletion-requested multimedia data.

8. The method of claim 7, further comprising:
deleting the identification information of the deletion-requested multimedia data from the recording key database, when the identification information of other multimedia data has been mapped to the extracted recording key information.

9. The method of claim 7, wherein the encryption key comprises at least one of a Service Encryption Key (SEK) and a Program Encryption Key (PEK).

10. The method of claim 9, wherein the recording key information comprises at least one of ID information of the SEK and ID information of the PEK.

11. An apparatus for managing encryption keys by a mobile communication terminal connected to a smartcard that stores the encryption keys, the apparatus comprising:
a storage unit for storing one or more encrypted multimedia data files;
a recording key database for storing mapping data between recording key information extracted from stream information included in the one or more encrypted multimedia data files and identification information of the one or more encrypted multimedia data files;
a communication interface unit for transmitting an encryption key deletion request to the smartcard; and
a controller for, when receiving a deletion request of one of the one or more encrypted multimedia data files, extracting recording key information from stream information included in the deletion-requested multimedia data file, determining whether the extracted recording key information has been mapped to identification information of another multimedia data file by referring to the recording key database, and controlling the communication interface unit to transmit an encryption key deletion request to the smartcard when the extracted recording key information has not been mapped to the identification information of another multimedia data file.

12. The apparatus of claim 11, wherein the controller deletes the identification information of the deletion-requested multimedia data file from the recording key database when the extracted recording key information has been mapped to the identification information of another multimedia data file.

13. The apparatus of claim 11, wherein the controller, when receiving new encrypted multimedia data from a Digital Multimedia Broadcast (DMB) service provider, extracts recording key information corresponding to an encryption key necessary for decryption of the received new multimedia data from stream information included in the received new multimedia data, determines whether the extracted recording key information has been previously stored in the recording key database, maps the extracted recording key information to identification information of the received new multimedia data and stores mapping data therebetween when the extracted recording key information has not been previously stored in the recording key database, and transmits an encryption key validity term renewal request including the extracted recording key information to the smartcard through the communication interface unit.

14. The apparatus of claim 13, wherein the controller maps the recording key information stored in the recording key database to the identification information of the received new multimedia data and stores mapping data therebetween, when the extracted recording key has been previously stored in the recording key database.

15. The apparatus of claim 11, wherein the encryption key comprises at least one of a Service Encryption Key (SEK) and a Program Encryption Key (PEK).

16. The apparatus of claim 15, wherein the recording key information comprises at least one of ID information of the SEK and ID information of the PEK.
